(19) United States
(12) Patent Application Publication
(10) Pub. No.: US 2014/0043677 A1
(43) Pub. Date: Feb. 13, 2014

(54) INFRARED-CUT FILTER OF LOW COST AND HIGH QUALITY AND LENS MODULE

(71) Applicant: HON HAI PRECISION INDUSTRY CO., LTD., New Taipei (TW)

(72) Inventors: GA-LANE CHEN, Santa Clara, CA (US); CHUNG-PEI WANG, New Taipei (TW)

(73) Assignee: HON HAI PRECISION INDUSTRY CO., LTD., New Taipei (TW)

(21) Appl. No.: 13/740,233

(22) Filed: Jan. 13, 2013

(30) Foreign Application Priority Data
Aug. 10, 2012 (TW) 101128931

(51) Int. Cl. G02B 13/14

(52) U.S. Cl. CPC G02B 13/14
USPC 359/356; 359/359

(57) ABSTRACT

An infrared-cut (IR-cut) filter includes a substrate and an IR-cut film coated on the substrate. The IR-cut consists of thirty-two high-refractive layers and thirty-two low-refractive layers alternately stacked on the substrate. The first high-refractive layer is in contact with the substrate and the first low-refractive layer is coated on the first high-refractive layer. Transmissivity of the IR-cut film at wavelengths from about 400 nm to about 800 nm is greater than about 90%, while transmissivity of the IR-cut film at wavelengths from about 850 nm to about 1300 nm is less than about 1%, and transmissivity of the IR-cut film at wavelength 795 nm is about 50%.

### BACKGROUND

1. Technical Field

The present disclosure relates to infrared-cut (IR-cut) filters and, particularly to an IR-cut filter with a low cost and a high quality, and a lens module having the IR-cut filter.

2. Description of Related Art

Generally, the fewer layers an IR-cut film has, the lower the cost of the film, however, optical properties of the IR-cut films suffer.

Therefore, it is desirable to provide an IR-cut filter and a lens module, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a cross-sectional schematic view of an IR-cut filter, according to an embodiment.

FIG. 2 is a graph showing a wavelength-transmissivity characteristic curve of the IR-cut filter of FIG. 1.

FIG. 3 is a cross-sectional schematic view of a lens module, according to an embodiment.

### DETAILED DESCRIPTION

Embodiments of the present disclosure will now be described in detail with reference to the drawings.

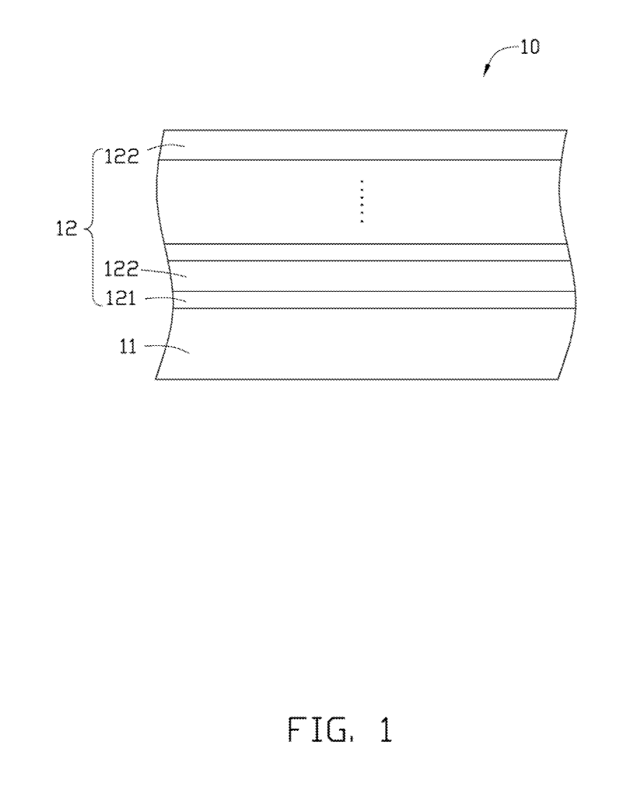

Referring to FIG. 1, an IR-cut filter 10 includes a substrate 11 and an IR-cut film 12 coated on the substrate 11.

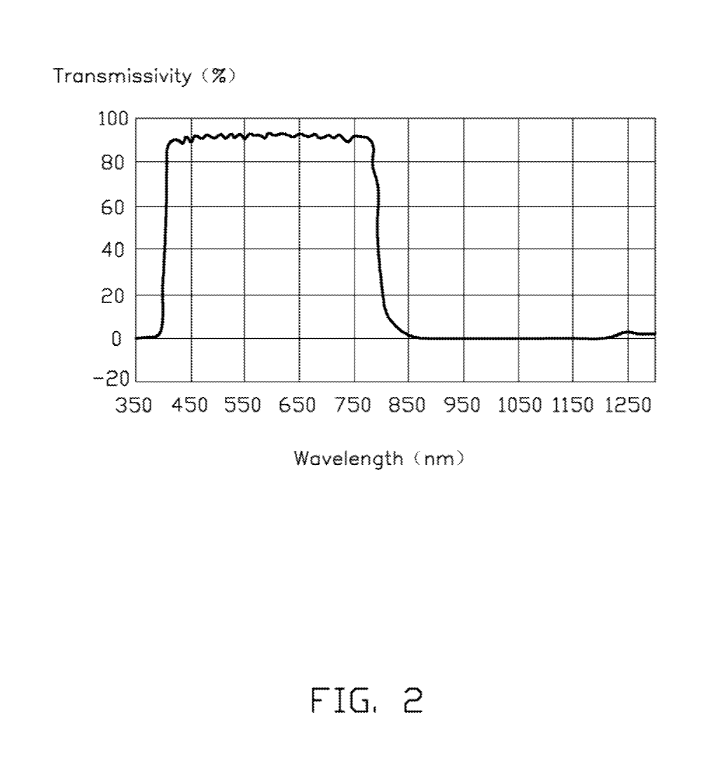

Also referring to FIG. 2, the IR-cut film 12 includes thirty-two high-refractive layers 121 and thirty-two low-refractive layers 122 alternately stacked on the substrate 11. The first high-refractive layer 121 is in contact with the substrate 11 and the first low-refractive layer 122 is coated on the first high-refractive layer 121.

As compared with conventional IR-cut films which typically have more than sixty-four layers, the number of the layers is reduced and thus a cost of the IR-cut filter 10 is reduced.

Transmissivity of the IR-cut film 12 at wavelengths from about 400 nm to about 800 nm (i.e., visible light wavelengths) is greater than about 90%, while transmissivity of the IR-cut film 12 at wavelengths from about 850 nm to about 1300 (i.e., IR wavelengths) nm is less than about 1%. Transmissivity of the IR-cut film 12 at a wavelength of 795 nm is about 50%.

That is, optical properties of the IR-cut film 12 (i.e., the wavelength-transmissivity characteristic) is maintained at a high level or improved, as compared to conventional IR filters.

The IR-cut film 12 can be formed by various mechanical and chemical deposition methods, such as vacuum vapor deposition. The high-refractive layers 121 can be made from titanium dioxide (TiO₂) with a refractive index of about 2.705. The low-refractive layers 122 can be made from silicon dioxide (SiO₂) with a refractive index of about 1.499.

Thicknesses of the layers of the IR-cut film 12 satisfy conditions listed in Table 1:

TABLE 1

| Layer-order | Thickness(nm) |
|---|---|
| 1 | 13.07 ± 0.5 |
| 2 | 31.64 ± 0.5 |
| 3 | 116.37 ± 0.5 |
| 4 | 29.57 ± 0.5 |
| 5 | 10.07 ± 0.5 |
| 6 | 167.97 ± 0.5 |
| 7 | 16.5 ± 0.5 |
| 8 | 51.1 ± 0.5 |
| 9 | 17.81 ± 0.5 |
| 10 | 105.95 ± 0.5 |
| 11 | 8.07 ± 0.5 |
| 12 | 53.46 ± 0.5 |
| 13 | 109.35 ± 0.5 |
| 14 | 175.35 ± 0.5 |
| 15 | 104.29 ± 0.5 |
| 16 | 170.18 ± 0.5 |
| 17 | 101.38 ± 0.5 |
| 18 | 168.69 ± 0.5 |
| 19 | 103.71 ± 0.5 |
| 20 | 169.06 ± 0.5 |
| 21 | 102.36 ± 0.5 |
| 22 | 175.56 ± 0.5 |
| 23 | 110.28 ± 0.5 |
| 24 | 184.3 ± 0.5 |
| 25 | 114.35 ± 0.5 |
| 26 | 189.64 ± 0.5 |
| 27 | 110.43 ± 0.5 |
| 28 | 11.53 ± 0.5 |
| 29 | 8.01 ± 0.5 |
| 30 | 188.71 ± 0.5 |
| 31 | 27.91 ± 0.5 |
| 32 | 14.73 ± 0.5 |
| 33 | 94.19 ± 0.5 |
| 34 | 28.56 ± 0.5 |
| 35 | 20.93 ± 0.5 |
| 36 | 148.93 ± 0.5 |
| 37 | 8.03 ± 0.5 |
| 38 | 44.93 ± 0.5 |
| 39 | 107.64 ± 0.5 |
| 40 | 8.21 ± 0.5 |
| 41 | 12.62 ± 0.5 |
| 42 | 177.19 ± 0.5 |
| 43 | 10.41 ± 0.5 |
| 44 | 11.1 ± 0.5 |
| 45 | 105.54 ± 0.5 |
| 46 | 26.66 ± 0.5 |
| 47 | 8.3 ± 0.5 |
| 48 | 173.24 ± 0.5 |
| 49 | 20.28 ± 0.5 |
| 50 | 20.81 ± 0.5 |
| 51 | 103.76 ± 0.5 |
| 52 | 25.51 ± 0.5 |
| 53 | 18.05 ± 0.5 |
| 54 | 165.16 ± 0.5 |
| 55 | 11.15 ± 0.5 |
| 56 | 30.89 ± 0.5 |
| 57 | 100.25 ± 0.5 |
| 58 | 15.96 ± 0.5 |
| 59 | 17.59 ± 0.5 |
| 60 | 162.08 ± 0.5 |
| 61 | 8 ± 0.5 |
| 62 | 25.05 ± 0.5 |
| 63 | 111.99 ± 0.5 |
| 64 | 93.38 ± 0.5 |

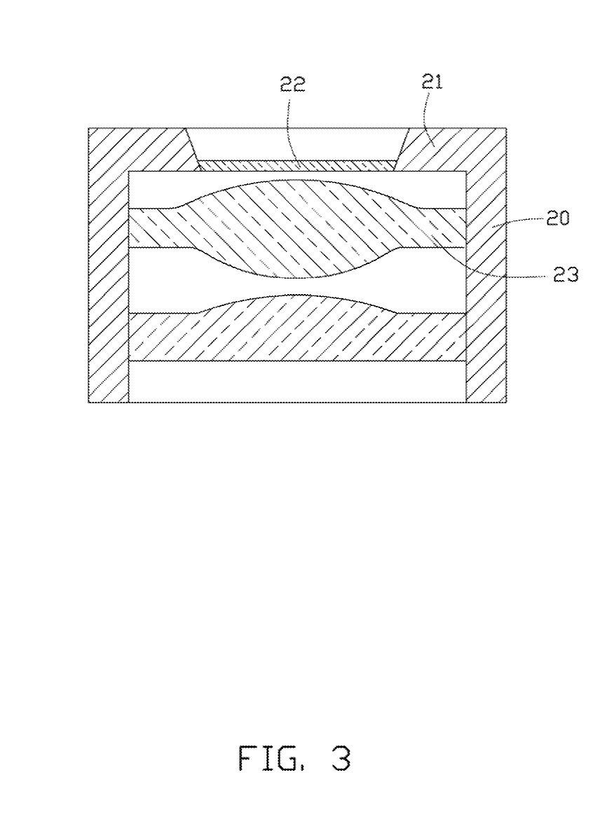

Referring to FIG. 3, a lens module 20, according to an embodiment, includes a lens barrel 21, a cover glass 22, and two lenses 23. The cover glass 22 and the lenses 23 are held in the lens barrel 21. The cover glass 22 is made of the IR-cut filter 10 and is most adjacent to the object-side of the lens barrel 21, thus protecting the lenses 23 from being damaged. To enhance mechanical strength of the cover glass 22, the substrate 11 can be made from sapphire, as sapphire has excellent mechanical strength.

The number of the lenses 23 is not limited to this embodiment but can be set depending on need. For example, in another embodiment, the lens module 23 may only have one lens.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. An infrared-cut (IR-cut) filter, comprising:
a substrate; and
an IR-cut film coated on the substrate, the IR-cut consisting of thirty-two high-refractive layers and thirty-two low-refractive layers alternately stacked on the substrate, wherein the first high-refractive layer is in contact with the substrate and the first low-refractive layer is coated on the first high-refractive layer;
wherein a transmissivity of the IR-cut film at wavelengths from about 400 nm to about 800 nm is larger than about 90%, while a transmissivity of the IR-cut film at wavelengths from about 850 nm to about 1300 nm is less than about 1%, and a transmissivity of the IR-cut film at wavelength 795 nm is about 50%.

2. The IR-cut filter of claim 1, wherein the substrate is made of sapphire.

3. The IR-cut filter of claim 1, wherein the high-refractive layers are made from titanium dioxide.

4. The IR-cut filter of claim 1, wherein the low-refractive layers are made from silicon dioxide.

5. The IR-cut filter of claim 1, wherein thicknesses of the layers of the IR-cut film satisfy the following table:

| Layer-order | Thickness(nm) |
|---|---|
| 1 | 13.07 ± 0.5 |
| 2 | 31.64 ± 0.5 |
| 3 | 116.37 ± 0.5 |
| 4 | 29.57 ± 0.5 |
| 5 | 10.07 ± 0.5 |
| 6 | 167.97 ± 0.5 |
| 7 | 16.5 ± 0.5 |
| 8 | 51.1 ± 0.5 |
| 9 | 17.81 ± 0.5 |
| 10 | 105.95 ± 0.5 |
| 11 | 8.07 ± 0.5 |
| 12 | 53.46 ± 0.5 |
| 13 | 109.35 ± 0.5 |
| 14 | 175.35 ± 0.5 |
| 15 | 104.29 ± 0.5 |
| 16 | 170.18 ± 0.5 |
| 17 | 101.38 ± 0.5 |
| 18 | 168.69 ± 0.5 |
| 19 | 103.71 ± 0.5 |
| 20 | 169.06 ± 0.5 |
| 21 | 102.36 ± 0.5 |
| 22 | 175.56 ± 0.5 |
| 23 | 110.28 ± 0.5 |
| 24 | 184.3 ± 0.5 |
| 25 | 114.35 ± 0.5 |
| 26 | 189.64 ± 0.5 |
| 27 | 110.43 ± 0.5 |
| 28 | 11.53 ± 0.5 |
| 29 | 8.01 ± 0.5 |
| 30 | 188.71 ± 0.5 |
| 31 | 27.91 ± 0.5 |
| 32 | 14.73 ± 0.5 |
| 33 | 94.19 ± 0.5 |
| 34 | 28.56 ± 0.5 |
| 35 | 20.93 ± 0.5 |
| 36 | 148.93 ± 0.5 |
| 37 | 8.03 ± 0.5 |
| 38 | 44.93 ± 0.5 |
| 39 | 107.64 ± 0.5 |
| 40 | 8.21 ± 0.5 |
| 41 | 12.62 ± 0.5 |
| 42 | 177.19 ± 0.5 |
| 43 | 10.41 ± 0.5 |
| 44 | 11.1 ± 0.5 |
| 45 | 105.54 ± 0.5 |
| 46 | 26.66 ± 0.5 |
| 47 | 8.3 ± 0.5 |
| 48 | 173.24 ± 0.5 |
| 49 | 20.28 ± 0.5 |
| 50 | 20.81 ± 0.5 |
| 51 | 103.76 ± 0.5 |
| 52 | 25.51 ± 0.5 |
| 53 | 18.05 ± 0.5 |
| 54 | 165.16 ± 0.5 |
| 55 | 11.15 ± 0.5 |
| 56 | 30.89 ± 0.5 |
| 57 | 100.25 ± 0.5 |
| 58 | 15.96 ± 0.5 |
| 59 | 17.59 ± 0.5 |
| 60 | 162.08 ± 0.5 |
| 61 | 8 ± 0.5 |
| 62 | 25.05 ± 0.5 |
| 63 | 111.99 ± 0.5 |
| 64 | 93.38 ± 0.5 |

6. A lens module, comprising:
a lens barrel;
a lens held in the lens barrel; and
a cover glass held in the lens barrel and positioned adjacent to an object side of the lens barrel to protect the lens from being damaged, the cover glass comprising:
a substrate; and
an IR-cut film coated on the substrate, the IR-cut consisting of thirty-two high-refractive layers and thirty-two low-refractive layers alternately stacked on the substrate, the first high-refractive layer in contact with the substrate, and the first low-refractive layer coated on the first high-refractive layer;
wherein a transmissivity of the IR-cut film at wavelengths from about 400 nm to about 800 nm is larger than about 90%, while a transmissivity of the IR-cut film at wavelengths from about 850 nm to about 1300 nm is less than about 1%, and a transmissivity of the IR-cut film at wavelength 795 nm is about 50%.
